(19) United States
(12) Patent Application Publication
(10) Pub. No.: US 2026/0043521 A1
(43) Pub. Date: Feb. 12, 2026

(54) TANK ARRANGEMENT FOR LIQUID HYDROGEN AND A METHOD FOR ITS OPERATION

(71) Applicant: DAIMLER TRUCK AG, Leinfelden-Echterdingen (DE)

(72) Inventor: Mila KÖLBIG, Stuttgart (DE)

(21) Appl. No.: 18/998,252

(22) PCT Filed: Jun. 23, 2023
(86) PCT No.: PCT/EP2023/067122

§ 371 Date: Jan. 24, 2025

(30) Foreign Application Priority Data
Jul. 27, 2022 (DE) 10 2022 118 834.5

(51) Int. Cl. F17C 7/04

(52) U.S. Cl. CPC F17C 7/04; F17C 2205/0332; F17C 2221/012; F17C 2223/0153; F17C 2223/035; F17C 2227/0302; F17C 2227/0383; F17C 2270/0176

(57) ABSTRACT

A tank arrangement includes a tank for liquid hydrogen, a boil-off management system having a catalyst, and a heater arranged on the hydrogen side behind a first pressure relief valve and thermally connected to the catalyst. The first pressure relief valve is configured to open when a specified first pressure is exceeded. The heater is designed as a passive metal hydride heater containing a metal hydride. A second pressure relief valve is arranged between the first pressure relief valve and the catalyst. The second pressure relief valve is configured to open when a specified second pressure, which is higher than the first pressure, is exceeded.

### BACKGROUND AND SUMMARY OF THE INVENTION

Exemplary embodiments of the invention relate to a tank arrangement for liquid hydrogen, as well as to a method for operating the tank arrangement.

In refueling processes for liquid hydrogen (sLH2), H₂ is stored at a temperature of −240° C. to −248° C. (25-33K) and up to 16 bar pressure. The removal of hydrogen has a cooling effect which maintains the temperature of the tank. If, however, no hydrogen is removed over a prolonged period of time (parking), the temperature and thus the pressure increases with time. If the maximum pressure of the tank is exceeded (˜20 bar), hydrogen is drained in order to avoid bursting the tank. This hydrogen has to be converted to water before it is able to be discharged to the surroundings. Therefore, the sLH2 tank has a boil-off management system (BOMS). Here, hydrogen catalytically reacts with oxygen to form water and can then be discharged. This has to also function at very low external temperatures of down to −40° C. The previously proposed catalysts do not function sufficiently however at ambient temperatures below −20° C. Therefore, they have to be preheated. According to the current prior art, this requires permanent monitoring of the tank system in order to be able to actively preheat the BOMS. So, the vehicle can never be completely turned off, even when parked. However, that should definitely be possible in order to save energy and to enable long parking times.

US 2003/0031970 A1 describes a boil-off gas treatment system for reliable combustion of a boil-off gas. The system processes a boil-off gas generated from a tank for liquid hydrogen installed in a vehicle powered with hydrogen. The system comprises a mixing device for introducing air into an outlet channel through which the boil-off gas flows from the tank for liquid hydrogen, and for mixing the air and the boil-off gas and for outputting a mixed gas; a catalytic combustion chamber for burning the mixed gas mixed by the mixing device, wherein the catalytic combustion chamber has an inlet, through which the mixed gas is introduced, and an outlet for removing combustion gas; an electric heater at the inlet side of the catalytic combustion chamber; and a control section for controlling the energy supply of the electric heating device.

Exemplary embodiments of the invention are directed to a novel tank arrangement for liquid hydrogen and a novel method for its operation.

A tank arrangement according to the invention comprises a tank for liquid hydrogen, a boil-off management system having a catalyst, and a heater. The heater can be arranged on the hydrogen side behind a first pressure relief valve and be thermally connected to the catalyst, wherein the first pressure relief valve is configured to open when a specified first pressure is exceeded. According to the invention, the heater is designed as a passive metal hydride heater, which contains a metal hydride. A second pressure relief valve can be arranged between the first pressure relief valve and the catalyst, wherein the second pressure relief valve is configured to open when a specified second pressure, which is higher than the first pressure, is exceeded.

In one embodiment, the heater is designed without an electric heating option.

In one embodiment, the heater is configured to exchange heat with the catalyst via heat conduction.

In one embodiment, the specified first pressure is 16 bar to 25 bar.

In one embodiment, the specified second pressure is 0.1 bar to 5 bar above the first pressure.

According to one aspect of the present invention, a method for operating a tank arrangement is proposed, comprising a tank for liquid hydrogen, a boil-off management system having a catalyst, and a heater arranged on the hydrogen side behind a first pressure relief valve and thermally connected to the catalyst, wherein the first pressure relief valve opens when a specified first pressure is exceeded and conducts hydrogen to the heater. According to the invention, the heater is designed as a passive metal hydride heater containing a metal hydride, which reversibly reacts with hydrogen, wherein a second pressure relief valve is arranged between the first pressure relief valve and the catalyst, wherein the second pressure relief valve opens when a specified second pressure, which is higher than the first pressure, is exceeded and conducts hydrogen to the catalyst.

In one embodiment, active heating, in particular electric heating, does not occur in the heater.

In one embodiment, the specified first pressure is 16 bar to 25 bar.

In one embodiment, the specified second pressure is 0.1 bar to 5 bar above the first pressure.

According to one aspect of the present invention, a method for incorporating a metal hydride in a container of a passive metal hydride heater for the above-described tank arrangement is proposed, wherein the metal hydride is incorporated before activation upon contact with air, and the activation takes place in the incorporated state, wherein either a vacuum is applied or the container is flushed with inert gas in order to remove air, and then a pressure change with hydrogen and/or temperature change in a vacuum or hydrogen atmosphere is carried out for the activation.

According to a further aspect of the present invention, a method for incorporating a metal hydride into a container of a passive metal hydride heater for the above-described tank arrangement is proposed, wherein both pressure relief valves are closed and subsequently an activated metal hydride is incorporated into the container in an inert atmosphere, wherein conduits to the container are then evacuated and flushed before the pressure relief valves are opened to the metal hydride and the passive metal hydride heater is flushed in order to remove the inert gas.

The solution according to the invention comprises a passive metal hydride heating device, suitable for sLH2 boil-off catalysts, without active monitoring and/or electric energy being required for heating. The device enables passive preheating of the BOMS (boil-off management system) and thus the required complete shutdown of the vehicle electronics when parked.

Furthermore, the heater can be used wherever there is a time lag between heat demand and heat generation.

Exemplary embodiments of the invention are explained in more detail in the following using drawings.

### BRIEF DESCRIPTION OF THE DRAWING FIGURES

Here:

FIG. 1 shows a schematic view of an arrangement comprising a tank for liquid hydrogen, a boil-off management system having a catalyst, and a passive metal hydride heater, and

FIG. 2 shows a schematic van't Hoff diagram.

### DETAILED DESCRIPTION

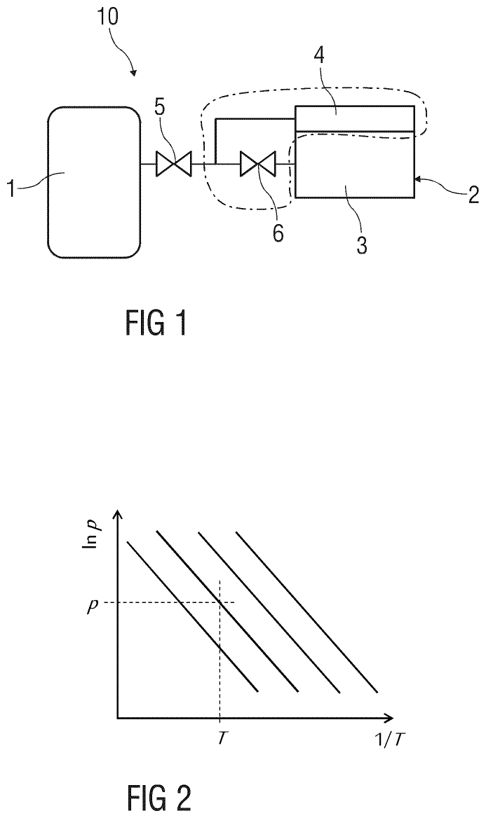

FIG. 1 is a schematic view of a tank arrangement 10 comprising a tank 1 for liquid hydrogen (sLH2), a boil-off management system 2 (BOMS) having a catalyst 3, and a passive metal hydride heater 4 (pMH-heater).

The passive metal hydride heater 4 for boil-off catalysts 3 without electric energy is based on the exo-/endothermic reaction of metal hydrides with hydrogen. Metal hydrides are metal alloys which reversibly react with hydrogen. The chemical equation is:

$${Me H}_{x} + \frac{1}{2} {y H}_{2} ↔ {Me H}_{x + y} + ΔH$$

Heat is released when hydrogen is absorbed (deposition), and the chemical equation operates from left to right. Heat is absorbed when hydrogen is desorbed (release), and the chemical equation operates from right to left. This reaction takes place automatically without external intervention.

The passive metal hydride heater 4 is placed on the hydrogen side behind a first pressure relief valve 5 and in front of the boil-off management system 2 and is thermally connected to the boil-off management system 2. In this case, heat transmission occurs through heat conduction.

If a specified pressure (for example 20 bar) is exceeded, the first pressure relief valve 5 opens and hydrogen flows to the metal hydride in the metal hydride heater 4. Here, an absorption reaction takes place automatically and heat is released. The heat is transmitted to the catalyst 3 of the boil-off management system 2 through heat conduction and heats this up.

Also, during this time hydrogen is not discharged to the surroundings due to the accumulation of the hydrogen in the metal hydride. Here the correct design of the passive metal hydride heater 4, in particular the correct selection and quantity of metal alloy, is important. Owing to the pressure-temperature correlation in the metal hydride-hydrogen reaction (see van't Hoff diagram, FIG. 2), the preheating temperature and preheating time can be set precisely by this alone, without the need for regulation. Thus, both the time as well as the temperature can take place without regulation and/or monitoring, i.e., passively.

When all spaces in the metal hydride grid are occupied with hydrogen (MH is full or saturated) and the catalyst 3 is preheated, the pressure increases again. If a further pressure threshold is exceeded (for example 20.5 bar), then a second pressure relief valve 6 opens, the second pressure relief valve 6 is connected downstream of the first pressure relief valve 5. Therefore, hydrogen flows through the boil-off management system 2, in particular the catalyst 3, and is oxidized to form water H₂O. The catalyst 3 heats up again due to the reaction.

The now warmer catalyst 3 emits heat to the passive metal hydride heater 4. The equilibrium pressure in the metal hydride increases above the pressure threshold (for example 20.5 bar) due to the increased temperature. The deposited hydrogen is desorbed (released) and oxidized in the boil-off management system 2, in particular the catalyst 3. The passive metal hydride heater 4 is regenerated by this and is available again for the next boil-off event. No additional energy is needed for this, since the heat is created anyway during the catalysis in the boil-off management system 2.

After the required hydrogen has been oxidized in the boil-off management system 2 and drained, the pressure relief valves 5, 6 close again. The entire system cools to ambient temperature again and is ready for the next boil-off event.

For each metal alloy, there is a defined correlation between pressure p and temperature T at which the reaction occurs. It is represented in the van't Hoff diagram. FIG. 2 is a schematic van't Hoff diagram.

Due to the material selection, it can now be determined at which temperature level with which pressure p the heat is to be created.

In the present case, an alloy is required that creates the highest possible temperature T at 20 bar and simultaneously creates a pressure p significantly above 20 bar with the regeneration conditions (desired catalyst temperature, at which regeneration is to begin), for example 25 bar at 50° C. or 100° C. or 300° C. Additional characteristics (e.g., cost, cycle stability, kinetics, hysteresis, load, etc.) can also play a role in the selection. LaNiAl alloys, for example, would be conceivable.

Due to the high energy density of metal hydrides (e.g., 20 KJ/mol H₂) and the relatively small quantity of catalyst that has to be heated, the preheater has the potential for a low weight and/or volume and thus also for low material costs.

A container for the passive metal hydride heater 4 has to fulfil the following tasks:
hold the metal hydride powder (for example approx. 100 g and/or approx. 50 ml),
produce a connection on the hydrogen side,
enable heat transmission to the catalyst 3,
temperature resistance up to the regeneration temperature or maximum temperature of the catalyst 3 (for example approx. 400° C.),
pressure resistance up to the regeneration pressure as well as a safety reserve (for example 20 bar to 50 bar).

Furthermore, the second pressure relief valve 6 is required.

Activated metal hydrides are usually not allowed to come into contact with air. Therefore, two possibilities for incorporating the metal hydride in the container of the passive metal hydride heater 4 exist:
The metal alloy is incorporated before activation upon contact with the air. The activation then takes place in the incorporated state. In the process, a vacuum is applied in order to remove air and a pressure change with the hydrogen atmosphere and/or a temperature change (pressure swing, temperature swing) is carried out for the activation. Many alloys can be activated after contact with air under moderate pressure/temperature conditions; this has to be checked in individual cases.
An activated metal hydride is incorporated in an inert atmosphere. This is possible when the container is closed by both pressure relief valves 5, 6. The conduits then have to be evacuated and flushed before the pressure relief valves 5, 6 open to the metal hydride and flush the passive metal hydride heater 4. For this purpose, the inert gas has to be removed sufficiently well.

The tank arrangement 10 can be used, for example, in a vehicle, in particular a commercial vehicle or a bus.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 tank
2 boil-off management system
3 catalyst
4 passive metal hydride heater
5 pressure relief valve, first pressure relief valve
6 pressure relief valve, second pressure relief valve
10 tank arrangement
P pressure
T temperature

1-10. (canceled)

11. A tank arrangement comprising:
a tank configured to hold liquid hydrogen;
a boil-off management system having a catalyst;
a heater arranged on a hydrogen side of the tank arrangement behind a first pressure relief valve, wherein the heater is thermally connected to the catalyst, wherein the first pressure relief valve is configured to open when a specified first pressure is exceeded, wherein the heater a passive metal hydride heater containing a metal hydride; and
a second pressure relief valve arranged between the first pressure relief valve and the catalyst, wherein the second pressure relief valve is configured to open when a specified second pressure, which is higher than the specified first pressure, is exceeded.

12. The tank arrangement of claim 11, wherein the boil-off management system does not include an electric heating option.

13. The tank arrangement of claim 11, wherein the heater is configured to exchange heat with the catalyst via heat conduction.

14. The tank arrangement of claim 11, wherein the specified first pressure is 16 bar to 25 bar.

15. The Tank arrangement of claim 11, wherein the specified second pressure is 0.1 bar to 5 bar above the first pressure.

16. A method for operating a tank arrangement comprising a tank configured to hold liquid hydrogen, a boil-off management system having a catalyst, and a heater arranged on a hydrogen side of the tank arrangement behind a first pressure relief valve and thermally connected to the catalyst, the method comprising:
opening the first pressure relief valve when a specified first pressure is exceeded and conducting hydrogen to the heater, wherein the heater is a passive metal hydride heater containing a metal hydride, which reversibly reacts with hydrogen; and
opening a second pressure relief valve when a specified second pressure, which is higher than the first pressure, is exceeded and conducting hydrogen to the catalyst, wherein the second pressure relief valve is arranged between the first pressure relief valve and the catalyst.

17. The method of claim 16, wherein electric heating does not occur in the boil-off management system.

18. The method of claim 16, wherein the specified first pressure is 16 bar to 25 bar or in the specified second pressure is 0.1 bar to 5 bar above the first pressure.

19. A method for incorporating a metal hydride in a container of a passive metal hydride heater for a tank arrangement comprising a tank configured to hold liquid hydrogen, a boil-off management system having a catalyst, a heater arranged on a hydrogen side of the tank arrangement behind a first pressure relief valve and thermally connected to the catalyst, and second pressure relief valve is arranged between the first pressure relief valve and the catalyst, the method comprising:
incorporating the metal hydride before activation of the metal hydride upon contact with air, and the activation of the metal hydride occurs in an incorporated state, wherein either a vacuum is applied or the container is flushed with inert gas in order to remove air, and then a pressure change with hydrogen or a temperature change in a vacuum or hydrogen atmosphere is performed for the activation of the metal hydride.

20. A method for incorporating a metal hydride in a container of a passive metal hydride heater for a tank arrangement comprising a tank configured to hold liquid hydrogen, a boil-off management system having a catalyst, a heater arranged on a hydrogen side of the tank arrangement behind a first pressure relief valve and thermally connected to the catalyst, and second pressure relief valve is arranged between the first pressure relief valve and the catalyst, the method comprising:
closing the first and second pressure relief valves and subsequently incorporating an activated metal hydride into the container in an inert atmosphere, wherein conduits to the container are then evacuated and flushed before the first and second pressure relief valves are opened to the metal hydride and the passive metal hydride heater is flushed to remove inert gas.
